(19) United States
(12) Patent Application Publication
(10) Pub. No.: US 2010/0077667 A1
(43) Pub. Date: Apr. 1, 2010

(54) DOOR PANEL

(75) Inventors: Ryoji Uto, Tokyo (JP); Keitaro Yokokawa, Hyogo (JP); Eri Uchikoshi, Kobe (JP); Hiroe Takano, Hyogo (JP)

Correspondence Address: DARBY & DARBY P.C., P.O. BOX 770, Church Street Station, New York, NY, 10008-0770, US

(73) Assignee: CATERPILLAR JAPAN LTD., Tokyo (JP)

(21) Appl. No.: 12/518,324

(22) PCT Filed: Jul. 15, 2008
(86) PCT No.: PCT/JP2008/062739

§ 371 Date: Jun. 9, 2009

(30) Foreign Application Priority Data
Oct. 31, 2007 (JP) 2007-282980

(51) Int. Cl. E05D 15/00

(52) U.S. Cl. 49/381

(57) ABSTRACT

A door panel that is capable of ensuring sufficient strength at a portion where a hinge is attached to a double-panel structure including an outer panel and an inner panel, and is also capable of preventing entry of rain water or the like from the aforementioned portion, is provided. An internal reinforcing plate for mounting hinges is immovably sandwiched between the outer panel and the inner panel, which is affixed to the inner surface of the outer panel. The internal reinforcing plate has bolt insertion holes, and nuts that are conjoined with the reverse surface of the internal reinforcing plate. The inner panel includes hinge mounting surface portions provided at such a location as to overlap the internal reinforcing plate. The hinge mounting surface portions have bolt insertion holes. The hinges having bolt insertion holes are respectively brought into contact with the hinge mounting surface portions and fastened by tightening bolts inserted through these bolt insertion holes as well as nuts that are in screw engagement with the bolts.

This is a U.S. national phase application under U.S.C. § 371 of International Patent Application No. PCT/JP2008/062739, filed Jul. 15, 2008 and claims the benefit of Japanese Application No. 2007-282980, filed Oct. 31, 2007. The International Application was published in the Japanese language on May 7, 2009 as International Publication No. WO/2009/057358 under PCT Article 21(2). The contents of both applications are incorporated herein in their entirety.

### TECHNICAL FIELD

The present invention relates to a door panel that is provided with an outer panel and an inner panel.

### BACKGROUND OF THE INVENTION

FIG. 14 illustrates a hydraulic excavator 10, which is a work machine. The hydraulic excavator 10 includes a lower structure 11, an upper structure 12, a cab 13, a work equipment 14, and a power system 15 that includes an engine. The cab 13, the work equipment 14, and the power system 15 are mounted on the upper structure 12, which is rotatably mounted on the lower structure 11. The power system 15 is covered by a top cover 16, side doors 17,18, and other such components. The side doors 17,18 are mounted by hinges, which will be explained later, so as to be capable of opening and closing, and secured in the closed state by means of a latching device 19.

Hinges of a side door of this type are typically attached to a door panel through a reinforcing member (e.g. See Japanese Laid-open Patent Publication No. 2005-188219 (pages 5-6, and FIGS. 2-4) and Japanese Laid-open Patent Publication No. 2007-170114 (page 5, and FIG. 2)).

Examples of structures of a cover unit of a work machine include a double-panel structure including an outer panel and an inner panel, wherein the inner panel has a plurality of recessed portions, and the outer panel and the inner panel are affixed to each other by bonding the recessed portions of the inner panel to the outer panel and hemming the peripheral edge of the outer panel. Hinges are directly attached to a raised portion, which is the portion bulging relative to the recessed portions (e.g. See Japanese Laid-open Patent Publication No. 9-228412 (pages 2-3, and FIGS. 2-8)).

The conventional cover unit with the double-panel structure described above presents the possibility of insufficient strength, because the hinges are directly attached to the raised portion of the inner panel.

This problem may be solved by providing an internal reinforcing plate between the inner panel and the outer panel and welding or otherwise mounting the hinges to the internal reinforcing plate. If such is the case, an opening for mounting hinges may be formed by cutting away a substantial part of the inner panel. However, this requires sealing or other treatment of the cut edges of the opening due to the possibility of rain water or the like entering_into the machine body from the large opening for mounting hinges.

In order to solve the above problems, an object of the invention is to provide a door panel that is capable of ensuring sufficient strength at a portion where a hinge is attached to a double-panel structure including an outer panel and an inner panel, and is capable of preventing entry of rain water or the like from the aforementioned portion.

### SUMMARY OF THE INVENTION

The present invention relates to a door panel including an outer panel; an inner panel that is affixed to the inner surface of the outer panel and includes a raised portion formed at a location in the proximity of at least one of the ends of the inner panel so as to bulge away from the outer panel; and an internal reinforcing plate having a bolt insertion hole and affixed between the outer panel and the inner panel at a location corresponding to the one end of the inner panel. The inner panel includes a hinge mounting surface portion provided at such a location as to overlap the internal reinforcing plate and having a bolt insertion hole. The door panel further includes a hinge abutting the hinge mounting surface portion and having a bolt insertion hole; a bolt inserted through the bolt insertion hole of the hinge, the bolt insertion hole of the hinge mounting surface portion of the inner panel, and the bolt insertion hole of the internal reinforcing plate; and a nut screwed around the bolt.

The present invention can be conjoined with the reverse surface of the internal reinforcing plate.

The door panel according to the present invention has an additional feature in that the inner panel and the internal reinforcing plate are affixed to the inner surface of the outer panel by means of an adhesive, and also by a hemmed portion provided along the peripheral edge of the outer panel.

The present invention has an additional feature in that the bolt and the nut screwed around the bolt are used as a temporary fixing jig for temporarily fixing the internal reinforcing plate to the inner panel until the internal reinforcing plate is permanently fixed between the outer panel and the inner panel.

According to the present invention, the strength of the hinge mounting portion of the double-panel structure of the outer panel and the inner panel, in other words the portion to which the hinge is mounted, is ensured by immovably providing the internal reinforcing plate between the outer panel and the inner panel at a location at one of the ends of the outer panel and the inner panel. The inner panel includes a hinge mounting surface portion that is provided at such a location as to overlap the internal reinforcing plate. The hinge mounting surface portion and the hinge respectively have bolt insertion holes.

Therefore, the hinge abutting the hinge mounting surface portion is fixed, together with the internal reinforcing plate and the hinge mounting surface portion, by tightening the bolt inserted in the bolt insertion holes as well as the nut that is in screw engagement with the bolt. With the configuration as above, without sealing or other special treatment, it is possible to prevent entry of rain water or the like from the hinge mounting portion by means of a minimum number of bolt insertion holes and a nut and a bolt that close off the bolt insertion holes.

According to the present invention, the hinge can easily be attached merely by screwing the bolt into the nut that is conjoined with the reverse surface of the internal reinforcing plate.

The inner panel and the internal reinforcing plate are fixed to the inner surface of the outer panel by means of the adhesive and the hemmed portion, which is provided along the peripheral edge of the outer panel. Therefore, in addition to attaching the hinge by tightening the bolt and the nut, this configuration eliminates the necessity of the welding process during assembly of the door panel, making possible the simplification of the production facility and equipment.

According to the present invention, the hinge mounting nut and bolt can effectively be used as a temporary fixing jig for temporarily fixing the internal reinforcing plate to the inner panel. This configuration ensures solid fixing of the internal reinforcing plate without necessitating a special fixing jig for the internal reinforcing plate.

### BRIEF DESCRIPTION OF THE DRAWINGS

FIG. 1 is an exploded perspective view of a door panel according to an embodiment of the present invention.

FIG. 2 is a sectional view of a hinge mounting portion of the door panel.

FIG. 3 is a perspective view of the front side of the hinge mounting portion of the door panel.

FIG. 4 is a perspective view of the reverse side of the hinge mounting portion of the door panel.

FIG. 5 is an external view of the door panel.

FIG. 6 is a sectional view taken along the line VI-VI of FIG. 5.

FIG. 7 is a perspective view of the outer face of the door panel.

FIG. 8 is a perspective view of the inner face of the door panel.

FIG. 9 is an enlarged sectional view of the door panel.

FIG. 10 is an enlarged perspective view of the door panel.

FIG. 11 shows sectional views illustrating the mounting process of an internal reinforcing plate of the door panel, wherein (a) is a sectional view illustrating the internal reinforcing plate positioned in the inner panel and bonded thereto; (b) is a sectional view illustrating how the internal reinforcing plate and the inner panel are positioned in the area surrounded by the peripheral edge of the outer panel in the hemming process; and (c) is a sectional view illustrating how the internal reinforcing plate and the inner panel are immovably joined to the outer panel by hemming the outer panel.

FIG. 12(a) is a sectional view illustrating a process of temporarily fixing the internal reinforcing plate to the inner panel with a nut and bolt for mounting a hinge; (b) is a sectional view illustrating a process of conjoining the inner panel with the outer panel; (c) is a sectional view illustrating a state where a bolt is removed; and (d) is a sectional view illustrating a state where the hinge is mounted with the bolt.

FIG. 13 is a plan view of a work machine provided with the door panel.

FIG. 14 is a perspective view of a conventional work machine.

### DETAILED DESCRIPTION OF THE INVENTION

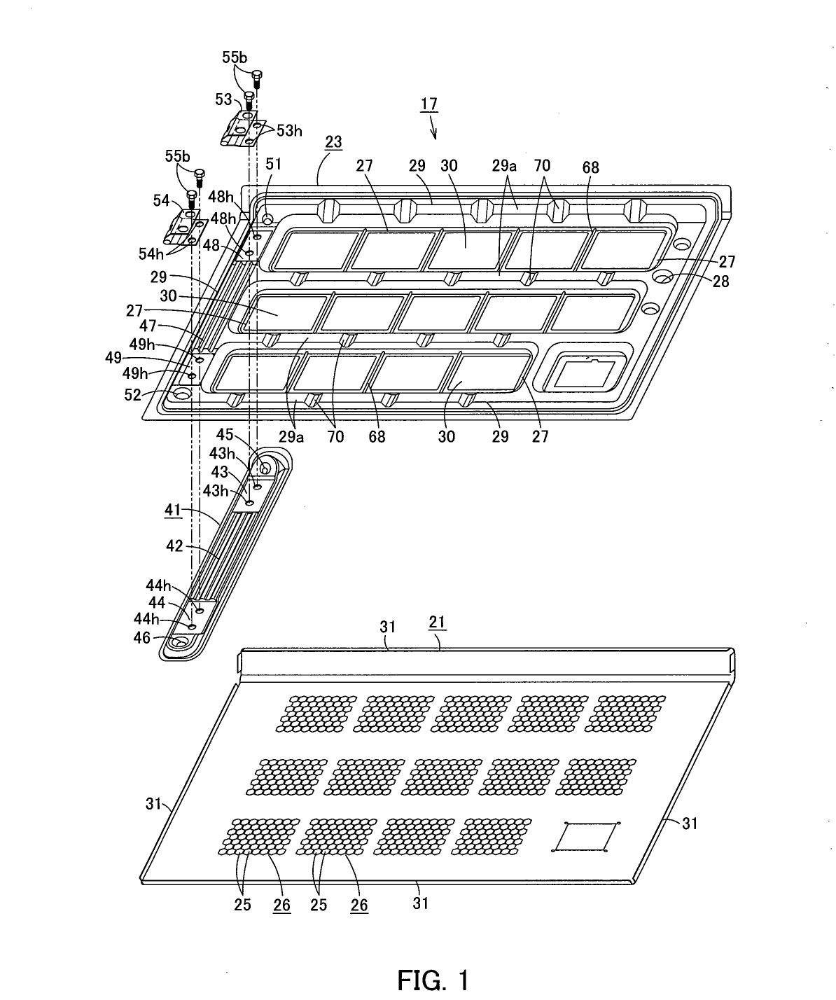

Next, the present invention is explained in detail hereunder, referring to an embodiment thereof shown in FIGS. 1 to 13.

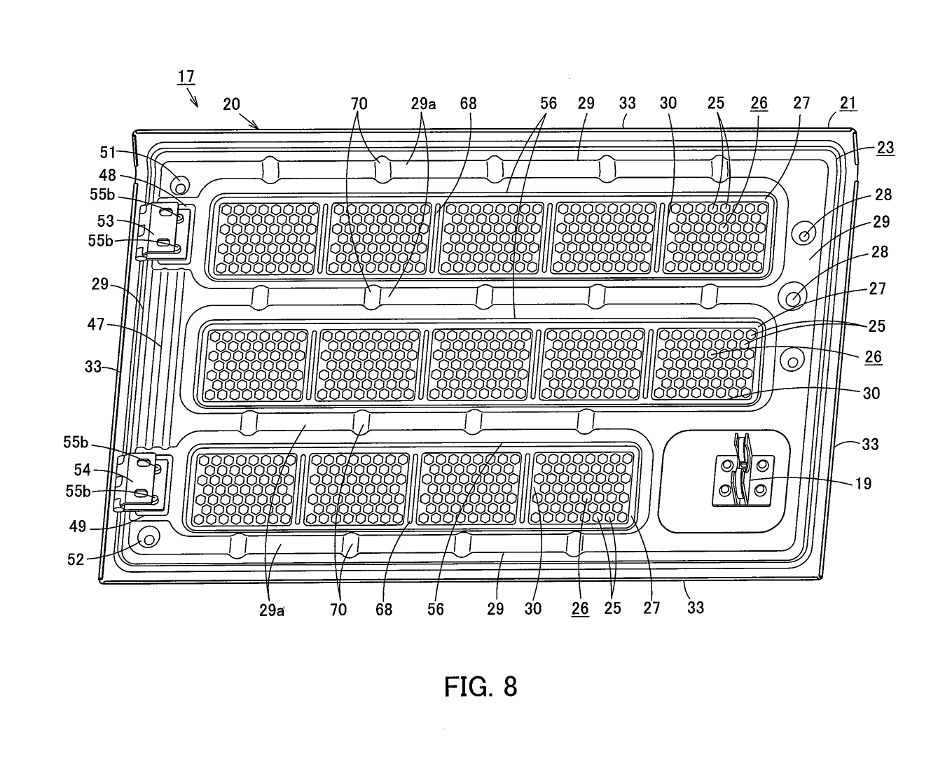

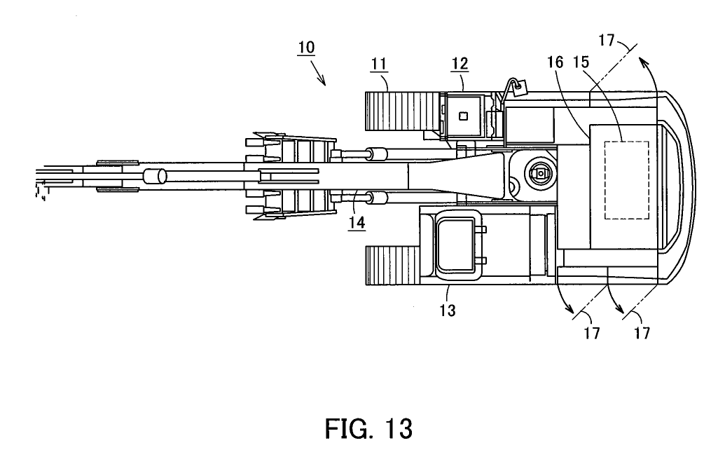

FIG. 13 illustrates a hydraulic excavator 10, which is a work machine. The hydraulic excavator 10 includes a lower structure 11, an upper structure 12, a cab 13, a work equipment 14, and a power system 15 that includes an engine. The cab 13, the work equipment 14, and the power system 15 are mounted on the upper structure 12, which is rotatably mounted on the lower structure 11. The power system 15 is covered by a top cover 16, side doors 17, and other such components. Each side door 17 is mounted by hinges, which will be explained later, so as to be capable of opening and closing, and maintained in the closed state by means of a latching device 19 (See FIG. 8).

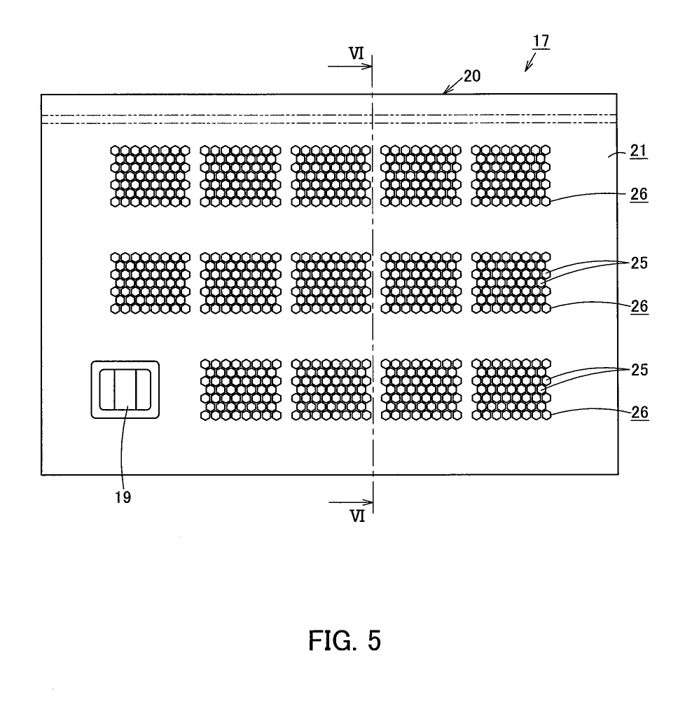

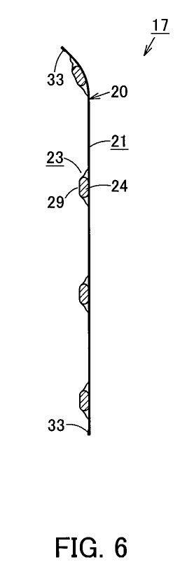

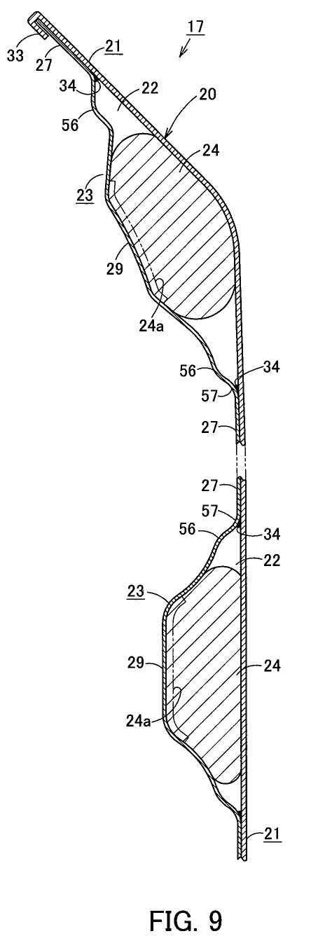

FIGS. 5 to 9 illustrate a door panel 20 of a side door 17. As illustrated in FIGS. 6 and 9, the door panel 20 includes an outer panel 21, an inner panel 23, and a foamed material 24. The inner panel 23 is formed by means of press molding so as to have an uneven surface with recessed portions and raised portions. The recessed portions are fixed to the inner surface of the outer panel 21, and a space 22 is formed between the raised portions and the inner surface of the outer panel 21 and filled with the aforementioned foamed material 24.

The outer panel 21 has a thickness ranging from 1.2 to 5.0 times that of the inner panel 23. In other words, an iron plate that is thinner than the outer panel 21 is used to form the inner panel 23. For example, if the outer panel 21 is an iron plate with a thickness of 1.2 mm, it is desirable to use a thin iron plate with a thickness of, for example, 0.6 or 0.8 mm to form the inner panel 23 in order to obtain sufficient strength and workability, which are reciprocal properties.

As illustrated in FIG. 9, the foamed material 24 is formed by heating an unactivated foaming sheet of a foaming material 24a, which is attached to the inner surface of the inner panel 23, so that the heated foaming material 24a is activated and expands inside the space 22 between the outer panel 21 and the inner panel 23. A highly expandable foaming rubber-base sound absorbing material that has an approximately 20-fold volumetric thermal expansion coefficient may desirably be used as the foaming material 24a. It is desirable to conduct the heating of the foaming material 24a during the baking finish process using a baking finish heating apparatus.

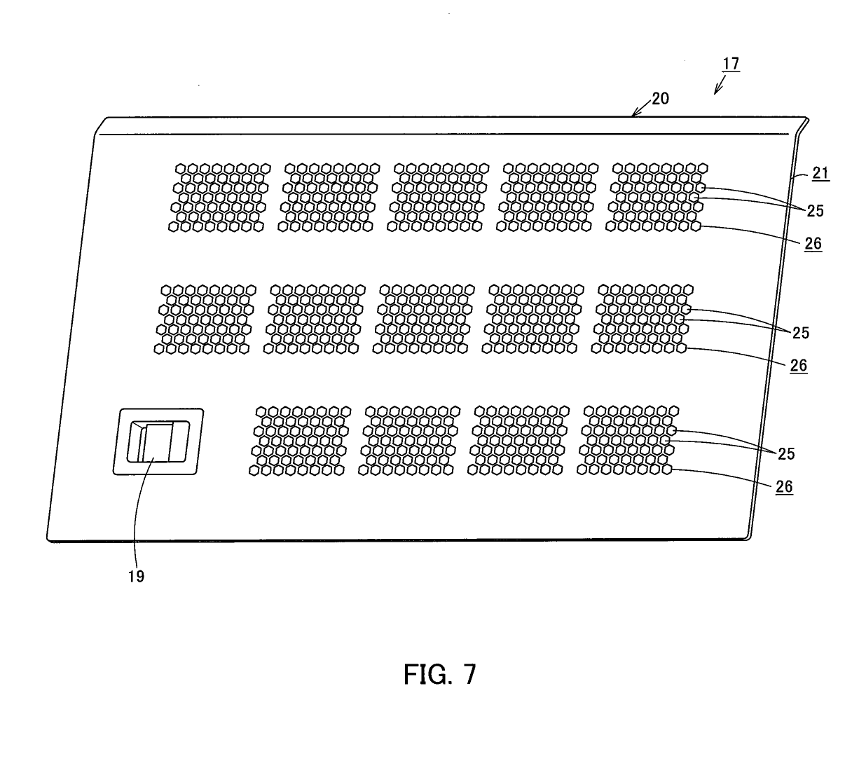

As illustrated in FIGS. 5 and 7, the outer panel 21 has a plurality of honeycomb ventilation hole sections 26 serving as ventilation hole clusters, each of which includes a plurality of regular hexagonal ventilation holes 25 that are formed through the material of the outer panel 21 so as to be arranged in a honeycomb pattern.

As illustrated in FIGS. 8 and 9, the inner panel 23 has adhering portions 27,28, which are the aforementioned recessed portions joined to the inner surface of the outer panel 21, and a raised portion 29 bulging from the adhering portions 27,28.

Of the adhering portions 27 of the inner panel 23, those surrounded by the raised portion 29 include three laterally extending rows, which are provided at locations respectively corresponding to the rows of the honeycomb ventilation hole sections 26 of the outer panel 21. Each one of these laterally extending adhering portion 27 is provided with ventilation openings 30, each of which is larger than each honeycomb ventilation hole section 26 of the outer panel 21.

To be more specific, the adhering portions 27 that are surrounded by the raised portion 29 and serve as a part of the recessed portions of the inner panel 23 are provided with a plurality of ventilation openings 30 formed therein. Each ventilation opening 30 corresponds to and is slightly larger than each respective honeycomb ventilation hole section 26 of the outer panel 21.

As illustrated in FIGS. 8 to 11, the peripheral edge 31 of the outer panel 21 is hemmed by folding the peripheral edge 31 of the outer panel 21 so as to curl over the peripheral edge 32 of the inner panel 23 and then pressing down the folded part. In other words, the outer panel 21 has a hemmed portion 33 that is formed by folding the peripheral edge 31 of the outer panel 21 so as to curl over the peripheral edge 32 of the inner panel 23 and then pressing down the folded part substantially flat so that the peripheral edge 31 of the outer panel 21 interlockingly secures the peripheral edge 32 of the inner panel 23.

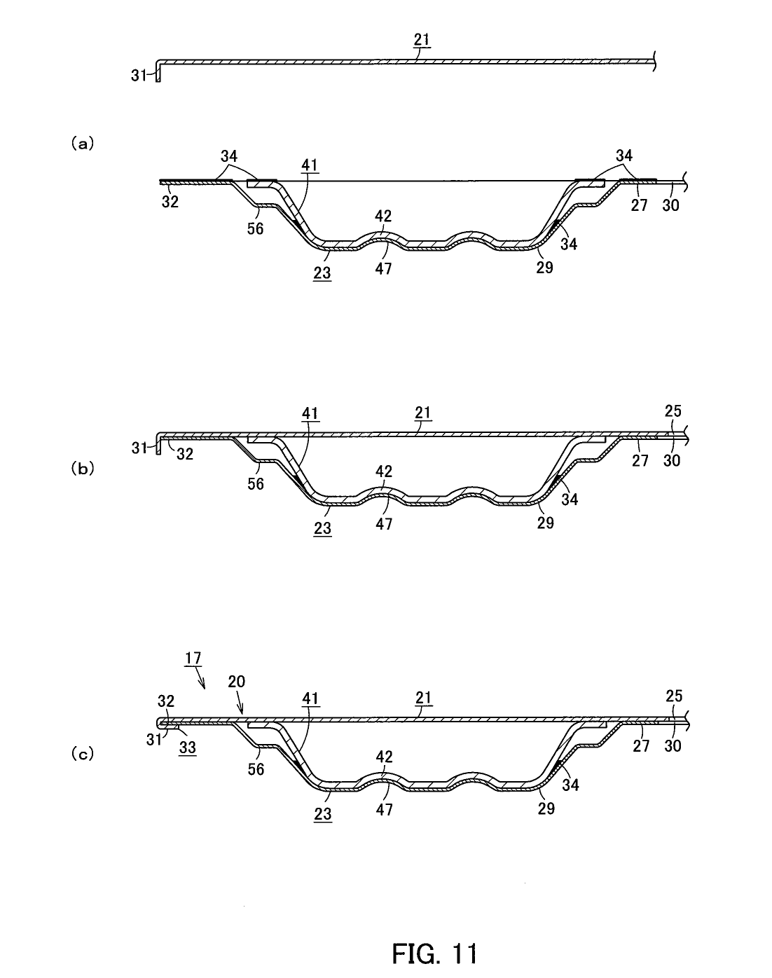

As illustrated in FIGS. 9 and 11, the adhering portions 27 of the inner panel 23 are bonded to the outer panel 21 with an adhesive 34, which joins as well as seals the outer panel 21 and the inner panel 23 together. The adhesive 34 may desirably be a paste-type structural adhesive having both viscous and thermosetting properties.

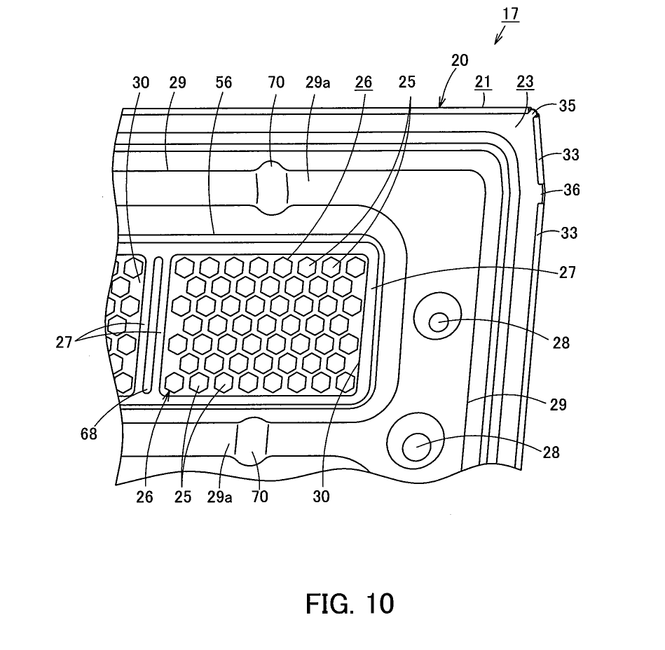

As illustrated in FIG. 10, the peripheral edge 31 of the outer panel 21 is provided with corner notches 35 and intermittent folded portion notches 36, each of which is formed by partially cutting away the folded part of a corner or an intermittent folded portion of the peripheral edge 31, respectively. The corner portions of the inner panel 23 that correspond to the corner notches 35 of the outer panel 21 are rounded.

FIG. 1 is an exploded perspective view of the side door 17, illustrating how an internal reinforcing plate 41 for mounting hinges is affixed. To be more specific, the internal reinforcing plate 41 is sandwiched between the outer panel 21 and the inner panel 23 in the state where the inner panel 23 is positioned on and affixed to the inner surface of the outer panel 21.

The internal reinforcing plate 41 is provided at the middle portion thereof with a corrugated adhering portion 42 including alternating ridges and furrows. Nut mounting surface portions 43,44 are respectively formed continuously with one end and the opposing end of the corrugated adhering portion 42. A plurality of bolt insertion holes 43h or 44h are formed in each nut mounting surface portion 43 or 44. A positioning fitting portion 45 and a positioning fitting portion 46, both of which have a concave shape, are formed adjacent to the nut mounting surface portions 43,44, respectively.

At the location corresponding to the internal reinforcing plate 41, the inner panel 23 is provided with a corrugated adhering portion 47 including alternating ridges and furrows. The corrugated adhering portion 47 is formed at the middle part of the hinge-attaching end of the raised portion 29 of the inner panel 23. Hinge mounting surface portions 48,49 are respectively formed adjacent to one end and the opposing end of the corrugated adhering portion 47. Each hinge mounting surface portion 48 or 49 is a flat surface and has a plurality of bolt insertion holes 48h or 49h formed therein. A positioning fitting portion 51 and a positioning fitting portion 52, both of which are in the shape of a protrusion protruding downward, are formed adjacent to the hinge mounting surface portions 48,49, respectively.

The two positioning fitting portions 45,46 of the internal reinforcing plate 41 have different dimensions, and, correspondingly, the positioning fitting portions 51,52 of the inner panel 23, too, have different dimensions. The positioning fitting portion 45 and the positioning fitting portion 51, which are respectively formed at mutually corresponding locations on the internal reinforcing plate 41 and the inner panel 23, fit to each other in a male-female engagement. The positioning fitting portion 46 and the positioning fitting portion 52, which are respectively formed at another pair of mutually corresponding locations on the internal reinforcing plate 41 and the inner panel 23, fit to each other in a male-female engagement.

Hinges 53,54, each of which has a plurality of bolt insertion holes 53h or 54h, respectively abut the hinge mounting surface portions 48,49 of the inner panel 23.

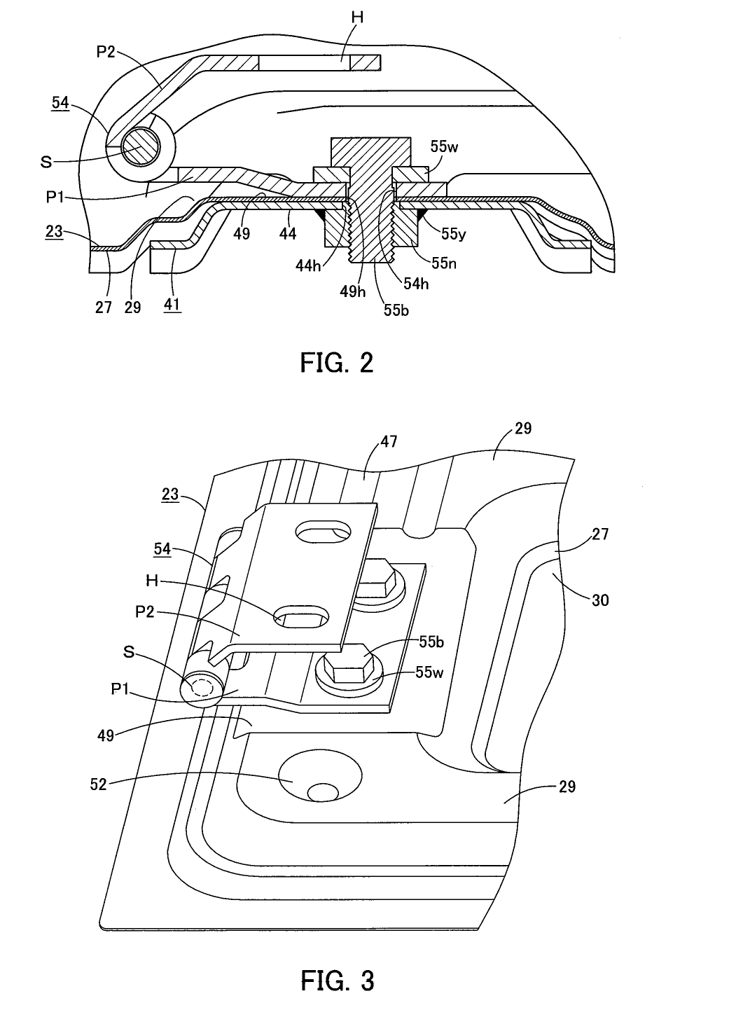

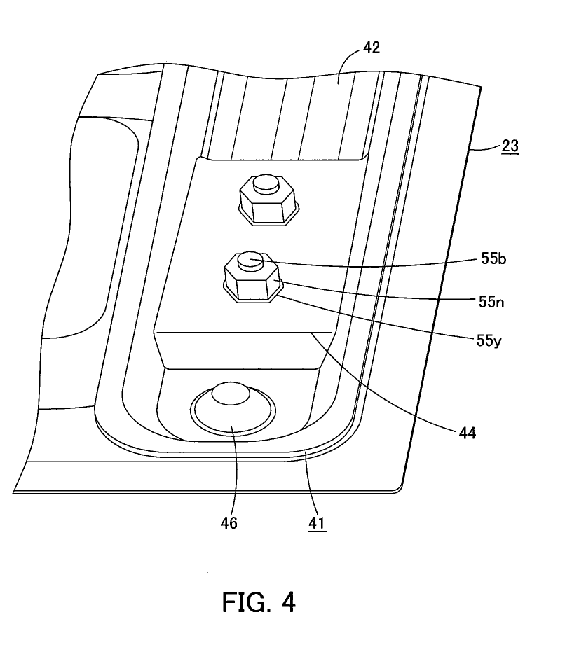

As illustrated in FIGS. 2 and 3, each hinge 53 or 54 has a plate P1 and another plate P2. The plate P1 is adapted to be fixed onto the hinge mounting surface portion 48 or 49 of the inner panel 23, and the plate P2 is pivotally connected to the plate P1 through a shaft member S. Elongated holes H for receiving bolts therein for attaching the side door 17 to a frame provided at the machine body are formed in each plate P2.

As illustrated in FIGS. 2 and 4, nuts 55n are conjoined with the reverse surface of each nut mounting surface portion 43 or 44 of the internal reinforcing plate 41 beforehand, by bonding or welding. Each nut 55n is provided concentrically with each respective bolt insertion hole 43h or 44h. The drawings illustrate a welded portion 55y.

The bolts 55b inserted into the bolt insertion holes 53h,54h of the hinges 53,54 and the bolt insertion holes 48h,49h of the hinge mounting surface portions 48,49 of the inner panel 23 through washers 55w are screwed into the nuts 55n, which are conjoined with the reverse surface of the nut mounting surface portions 43,44 of the internal reinforcing plate 41. Thus, the hinges 53,54 are fastened by tightening these nuts 55n and bolts 55b.

FIG. 11 illustrates a method of producing the door panel 20 incorporating the internal reinforcing plate 41. The inner panel 23 includes the raised portion 29, which is the portion bulging away from the outer panel 21. As illustrated in FIG. 11(a), the internal reinforcing plate 41 is positioned inside the raised portion 29 of the inner panel 23, with the thermosetting adhesive 34 being already applied between the corrugated adhering portions 42,47. The thermosetting adhesive 34 is also applied to the joint surfaces of the internal reinforcing plate 41 and the inner panel 23 to be joined to the outer panel 21. As illustrated in FIG. 11(b), in the state where the peripheral edge 31 of the outer panel 21 is folded but still open as the hemming process is not yet completed, and the adhesive has been applied to the inner panel 23, the inner panel 23 and the internal reinforcing plate 41 are positioned on the outer panel 21 by fitting the inner panel 23 in the area surrounded by the peripheral edge 31 of the outer panel 21 so that the internal reinforcing plate 41 is sandwiched between the outer panel 21 and the inner panel 23. Then, as illustrated in FIG. 11(c), the inner panel 23 and the internal reinforcing plate 41 are immovably joined to and sealed along the inner surface of the outer panel 21 by hemming the peripheral edge 31 of the outer panel 21 so that the peripheral edge 31 is folded while curling over the peripheral edge 32 of the inner panel 23.

As illustrated in FIG. 9, the inner panel 23 includes the raised portion 29 bulging from the recessed adhering portions 27, which are in direct contact with the outer panel 21. A reinforcing deformed portion 56 is formed in a step-like shape along the middle of each sloping side of the raised portion 29. The adhering portions 27 of the inner panel 23 are bonded to the outer panel 21 with the adhesive 34. The raised portion 29 has ascending portions 57, each of which has an arc-shaped cross section and continuously extends along the foot of the raised portion 29 rising from the corresponding adhering portion 27.

As illustrated in FIG. 8, the raised portion 29 and each reinforcing deformed portion 56 are formed in an endless manner along the recessed adhering portions 27.

As illustrated in FIG. 10, the adhering portions 27 of the inner panel 23, which are bonded to the outer panel 21 with the adhesive 34, are provided with adhesive retaining portions 68 for retaining the adhesive 34. Each adhering portion 27 surrounded by the raised portion 29 includes vertically extending portions extending along the ventilation openings 30, which are formed at locations corresponding to the groups of ventilation holes 25 of the outer panel 21. To be more specific, each vertically extending portion of the adhering portions 27 extends between a ventilation opening 30 and a ventilation opening 30 adjacent thereto, and the adhesive retaining portions 68 of the inner panel 23 are formed in the shape of a continuously extended raised portion respectively in these vertically extending portions and extend along the ventilation openings 30.

The raised portion 29 of the inner panel 23 is so formed as to bulge from the adhering portions 27,28 and has reinforcing raised portions 29a, each of which is a continuously extending raised portion. The reinforcing raised portions 29a are provided at the vertical ends of the rows of ventilation openings 30 and extend along the laterally extending adhering portions 27, which are bonded to the outer panel 21. Furthermore, reinforcing indentations 70 are formed across the reinforcing raised portions 29a.

Next, a production process of the door panel 20 is explained.

As illustrated by two-dot chain line in FIG. 9, the foaming material 24a is attached to the inner surface of the raised portion 29 of the inner panel 23. As illustrated in FIG. 11(a), the internal reinforcing plate 41 for mounting hinges is joined to the reverse surface of the raised portion 29 of the inner panel 23, at a location in the proximity of one of the lateral ends of the inner panel 23, with the thermosetting adhesive 34 applied between the internal reinforcing plate 41 and the raised portion 29. Furthermore, the thermosetting adhesive 34, which is necessary for bonding the outer panel 21 thereto, is applied to the adhering portions 27, which serve as a part of the recessed portions of the inner panel 23, as well as to the internal reinforcing plate 41. As illustrated in FIG. 11(b), the outer panel 21 and the inner panel 23 are positioned and layered one on top of the other. As illustrated in FIG. 11(c), the inner panel 23 and the internal reinforcing plate 41 are joined to the inner surface of the outer panel 21 by hemming the peripheral edge 31 of the outer panel 21 so that the peripheral edge 31 is folded while curling over the peripheral edge 32 of the inner panel 23 and the folded parts are pressed down substantially flat.

Thereafter, the inner panel 23 and the internal reinforcing plate 41 are bonded to the outer panel 21 by heating the adhesive 34 using the baking finish heating apparatus to harden the adhesive 34. Then, as illustrated in FIG. 9, the foaming material 24a is expanded to fill the space 22 with the foamed material 24 by heating using the baking finish heating apparatus. Furthermore, the paint that has been sprayed beforehand onto the outer surface of the outer and inner panels 21,23 is baked thereon by heating using the baking finish heating apparatus.

For example, thermal hardening of the adhesive 34 is conducted by heating for 5 minutes at 150° C.; formation of the foamed material 24 by expansion by heating for 20 minutes at 150° C.; and baking finish by heating for 20 minutes at 180° C. to 200° C. Such heating can be performed by using a conventional baking finish heating apparatus.

Finally, as illustrated in FIGS. 1 to 4, the hinges 53,54 are respectively brought into contact with the hinge mounting surface portions 48,49 of the inner panel 23, and the bolts 55b, which are inserted through the bolt insertion holes 53h,54h of the hinges 53,54 and the bolt insertion holes 48h,49h of the hinge mounting surface portions 48,49, are screwed into the nuts 55n, which are affixed to the reverse surface of the nut mounting surface portions 43,44 of the internal reinforcing plate 41. As a result, the hinges 53,54 become fastened to the inner panel 23 and the internal reinforcing plate 41.

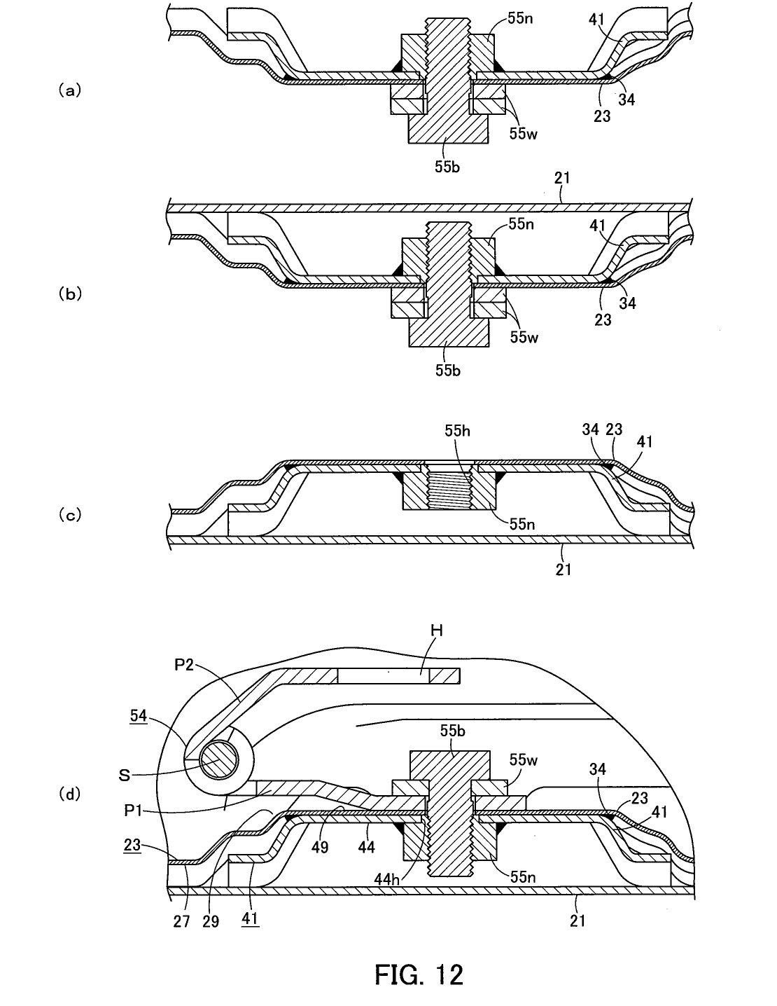

Next, FIG. 12 represents an example of using a hinge mounting structure for positioning and temporarily fixing the internal reinforcing plate 41 to the inner panel 23 during the production process of the door panel.

To be more specific, the internal reinforcing plate 41, which serves to reinforce the hinge mounting portions of the door panel 20, is positioned on the inner panel 23 by means of a male-female engagement of the positioning fitting portions 45,46 of the internal reinforcing plate 41 and the positioning fitting portions 51,52 of the inner panel 23. However, when the door panel is actually being assembled, it is necessary to temporarily secure the internal reinforcing plate 41 to the inner panel 23 with some kind of a jig until the internal reinforcing plate 41 is bonded to the inner panel 23 with the thermosetting adhesive 34 by heating in the heating furnace. Therefore, the hinge mounting structure by using the hinge mounting nuts 55n and bolts 55b is used for positioning and temporarily fixing the internal reinforcing plate 41 during the production of the door panel.

To explain in concrete terms, as illustrated in FIG. 12(a), the internal reinforcing plate 41 is temporarily fixed to the inner panel 23 by screwing and tightening the hinge mounting bolts 55b in the nuts 55n of the internal reinforcing plate 41 through the washers 55w and the inner panel 23; and as illustrated in FIG. 12(b), the inner panel 23 is conjoined with the outer panel 21 by, for example, hemming, and the panels 21,23 are conveyed into the heating furnace and heated therein so that the thermosetting adhesive 34 becomes hardened and fixes by bonding the internal reinforcing plate 41 to the inner panel 23. Thereafter, the bolts 55b are removed as illustrated in FIG. 12(c), and, as illustrated in FIG. 12(d), the hinges 53,54 are mounted by means of the bolts 55b and the nuts 55n. The structure and method of mounting the hinges 53,54 are as already explained, referring to FIGS. 1 to 4.

As explained above, the hinge mounting bolts 55b and the nuts 55n for screw engagement with the bolts 55b can effectively be used as a temporary fixing jig for temporarily fixing the internal reinforcing plate 41 to the inner panel 23 until the internal reinforcing plate 41 is permanently fixed between the outer panel 21 and the inner panel 23. This configuration ensures solid fixing of the internal reinforcing plate 41 without necessitating magnets or other special fixing jig for the internal reinforcing plate.

Next, the functions and effects of the embodiment illustrated in FIGS. 1 to 13 are explained hereunder.

As illustrated in FIG. 9, the hollow structure with a closed cross section formed of the outer panel 21 and the inner panel 23, which is thinner than the outer panel 21, can make the entire door panel 20 lighter. Furthermore, as the closed cross section of this hollow structure has sufficient height, being formed of the inner panel 23 and the outer panel 21 with a thickness greater than that of the inner panel 23, i.e. 1.2 to 5.0 times thicker than the inner panel 23, the door panel has sufficient strength against an external impact. Therefore, the embodiment provides a door panel that is light in weight and has sufficient strength at inexpensive cost.

Furthermore, the foamed material 24 filling the space between the outer panel 21 and the inner panel 23 is capable of absorbing sound and thereby effectively damping sound generated from the door panel itself and, consequently, provides high damping effect to reduce noise.

As illustrated in FIGS. 1 to 4, the strength of the hinge mounting portions of the double-panel structure of the outer panel 21 and the inner panel 23, in other words the portions to which the hinges 53,54 are respectively mounted, is ensured by immovably providing the internal reinforcing plate 41 between the outer panel 21 and the inner panel 23 at a location at one of the lateral ends of the two panels 21,23. The inner panel 23 includes hinge mounting surface portions 48,49 that are provided at such a location as to overlap the internal reinforcing plate 41. The hinge mounting surface portions 48,49 have bolt insertion holes 48h,49h, and the hinges 53,54 have bolt insertion holes 53h,54h. Therefore, the hinges 53,54 abutting the hinge mounting surface portions 48,49 are fixed, together with the internal reinforcing plate 41 and the hinge mounting surface portions 48,49, by tightening the bolts 55b inserted in the bolt insertion holes 43h,44h,48h,49h,53h,54h, and also the nuts 55n that are in screw engagement with the bolts 55b. With the configuration as above, without special treatment, such as closing off the opening with a sealing member against entry of rain water, it is possible to prevent entry of rain water or the like from the hinge mounting portions by means of a minimum number of bolt insertion holes and nuts 55n and bolts 55b that close off the bolt insertion holes.

The hinges 53,54 can easily be attached merely by screwing the bolts 55b into the nuts 55n that are conjoined with the reverse surface of the internal reinforcing plate 41.

The inner panel 23 and the internal reinforcing plate 41 are fixed to the inner surface of the outer panel 21 by means of the adhesive 34 and the hemmed portion 33, which is provided along the peripheral edge of the outer panel 21. Therefore, in addition to attaching the hinges 53,54 by tightening the bolts 55b and the nuts 55n, this configuration eliminates the necessity of the welding process during assembly of the door panel, making possible the simplification of the production facility and equipment. As the internal reinforcing plate 41 with the nuts 55n already welded to the reverse surface thereof is supplied as one of the parts to the door panel assembly line, there is no need of providing a welding process for the internal reinforcing plate 41 in the door panel assembly line.

Furthermore, in the embodiment described above, in order to completely prevent entry of rainwater, a packing or the like may be inserted in the portion fastened by tightening the bolts 55b and the nuts 55n.

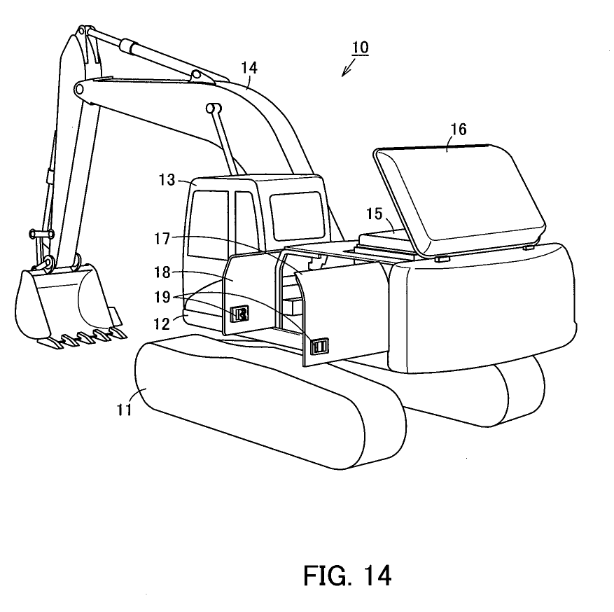

The present invention relates to a door panel that is applicable to a side door of a work machine, such as a hydraulic excavator illustrated in FIG. 13 or FIG. 14.

1. A door panel comprising:
an outer panel;
an inner panel affixed to an inner surface of the outer panel and including a raised portion formed at a location in the proximity of at least one of the ends of the inner panel so as to bulge away from the outer panel; and
an internal reinforcing plate having a bolt insertion hole and affixed between the outer panel and the inner panel, internal reinforcing plate being provided at a location at said one of the ends of the inner panel, wherein:
the inner panel includes a hinge mounting surface portion provided at such a location as to overlap the internal reinforcing plate and having a bolt insertion hole;
a hinge abutting the hinge mounting surface portion and having a bolt insertion hole;
a bolt inserted through the bolt insertion hole of the hinge, the bolt insertion hole of the hinge mounting surface portion of the inner panel, and the bolt insertion hole of the internal reinforcing plate; and
a nut screwed around the bolt.

2. A door panel as claimed in claim 1, wherein:
the nut is conjoined with the reverse surface of the internal reinforcing plate.

3. A door panel as claimed in claim 1, wherein:
the inner panel and the internal reinforcing plate are affixed to the inner surface of the outer panel by:
an adhesive; and
a hemmed portion provided along the peripheral edge of the outer panel.

4. A door panel as claimed in claim 1, wherein:
the bolt and the nut screwed around the bolt are used as a temporary fixing jig for temporarily fixing the internal reinforcing plate to the inner panel until the internal reinforcing plate is permanently fixed between the outer panel and the inner panel.
